(19) United States
(12) Patent Application Publication
(10) Pub. No.: US 2026/0079313 A1
(43) Pub. Date: Mar. 19, 2026

(54) HYBRID INTEGRATED OPTOELECTRONIC DEVICE

(71) Applicant: SHINKO ELECTRIC INDUSTRIES CO., LTD., Nagano (JP)

(72) Inventors: Hisashi KANEDA, Nagano (JP); Takashi OZAWA, Nagano (JP); Yuji FURUTA, Nagano (JP)

(21) Appl. No.: 19/330,048

(22) Filed: Sep. 16, 2025

(30) Foreign Application Priority Data
Sep. 19, 2024 (JP) 2024-162432
Mar. 26, 2025 (JP) 2025-051288

(51) Int. Cl. G02B 6/42

(52) U.S. Cl. CPC G02B 6/424; G02B 6/4224; G02B 6/4239; G02B 6/4245; G02B 6/4249; G02B 6/4259

(57) ABSTRACT

A hybrid integrated optoelectronic device includes an interconnect substrate, a photonic integrated circuit disposed on an upper surface of the interconnect substrate, an optical connection waveguide member disposed on the upper surface of the interconnect substrate; and a holding member configured to hold the photonic integrated circuit and the optical connection waveguide member, wherein the holding member is fixed to the upper surface of the interconnect substrate.

### CROSS-REFERENCE TO RELATED APPLICATIONS

The present application is based on and claims priority to Japanese Patent Applications No. 2024-162432 filed on Sep. 19, 2024 and No. 2025-051288 filed on Mar. 26, 2025, with the Japanese Patent Office, the entire contents of which are incorporated herein by reference.

### FIELD

The disclosures herein relate to hybrid integrated optoelectronic devices.

### BACKGROUND

Optical connection structures for connecting photonic integrated circuits to other components may be used in data centers or the like where various computers and data communication devices are installed. As an example of such optical connection structures, an optical connection waveguide member such as a planar lightwave circuit is fixedly bonded to the end face of an input/output waveguide of a photonic integrated circuit, thereby establishing optical connection therebetween (See, for example, Patent Document 1).

In the optical connection structure as described above, the photonic integrated circuit and the optical connection waveguide member are fixedly bonded with a small adhesion area, which results in a weak adhesion strength between them. As a result, applying stress to the connection between the photonic integrated circuit and the optical connection waveguide member poses a risk of connection breakage, and the connection reliability cannot be said to be high.

Accordingly, there may be a need for a hybrid integrated optoelectronic device having an optical connection structure with high connection reliability.

### Prior Art Documents

### Patent Document

[Patent Document 1] Japanese Laid-Open Patent Publication No. 2020-64211

### SUMMARY

According to an aspect of the embodiment, a hybrid integrated optoelectronic device includes an interconnect substrate, a photonic integrated circuit disposed on an upper surface of the interconnect substrate, an optical connection waveguide member disposed on the upper surface of the interconnect substrate; and a holding member configured to hold the photonic integrated circuit and the optical connection waveguide member, wherein the holding member is fixed to the upper surface of the interconnect substrate.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a cross-sectional view illustrating an example of a hybrid integrated optoelectronic device according to a first embodiment;

FIG. 2 is an axonometric view illustrating an example of the holding member according to the first embodiment;

FIG. 3 is a cross-sectional view illustrating an example of a method of making a hybrid integrated optoelectronic device according to the first embodiment;

FIG. 4 is a cross-sectional view illustrating an example of the use of the hybrid integrated optoelectronic device according to the first embodiment;

FIG. 5 is a cross-sectional view illustrating an example of a hybrid integrated optoelectronic device according to a first variation of the first embodiment;

FIG. 6 is an axonometric view illustrating an example of the holding member according to the first variation of the first embodiment;

FIG. 7 is a cross-sectional view illustrating an example of a manufacturing method of the hybrid integrated optoelectronic device according to the first variation of the first embodiment;

FIG. 8 is a cross-sectional view illustrating an example of a hybrid integrated optoelectronic device according to the second variation of the first embodiment; and

FIG. 9 is an axonometric view illustrating an example of the holding member according to the second variation of the first embodiment.

### DESCRIPTION OF EMBODIMENTS

Embodiments of the invention will be described below with reference to the accompanying drawings. In these drawings, the same components are denoted by the same reference numerals, and duplicate descriptions may be omitted.

### First Embodiment

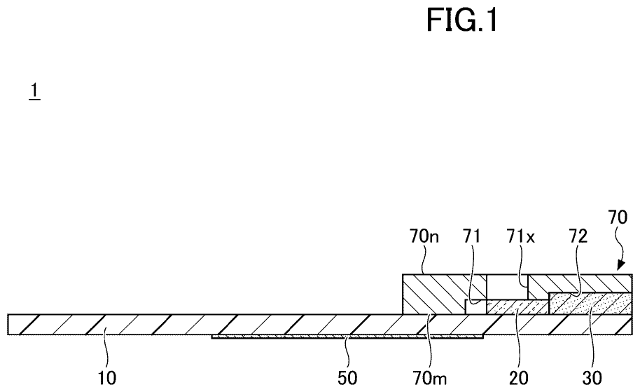

FIG. 1 is a cross-sectional view illustrating an example of a hybrid integrated optoelectronic device according to a first embodiment. Referring to FIG. 1, a hybrid integrated optoelectronic device 1 includes an interconnect substrate 10, a photonic integrated circuit 20, an optical connection waveguide member 30, a semiconductor device 50, and a holding member 70.

The interconnect substrate 10 is rectangular in plan view, for example. The interconnect substrate 10 is a resin substrate such as a glass epoxy substrate, for example, provided with interconnects made of copper or the like. The interconnect substrate 10 may be a multilayer interconnect substrate.

The photonic integrated circuit 20 is arranged on the upper surface of the interconnect substrate 10. The photonic integrated circuit 20 is, for example, flip-chip mounted on the upper surface of the interconnect substrate 10 in a face-down state.

The photonic integrated circuit 20 includes, for example, an optical waveguide, a light emitting element, a light receiving element, and the like on a substrate made of silicon or the like. The photonic integrated circuit 20 is sometimes referred to as silicon photonics or the like. The photonic integrated circuit 20 may have the function of converting optical signals, input from a fiber array or the like located outside the hybrid integrated optoelectronic device 1 through the optical connection waveguide member 30, into electrical signals for output to the semiconductor device 50. The photonic integrated circuit 20 may also have the function of converting electrical signals input from the semiconductor device 50 into optical signals for output to the fiber array or the like located outside the hybrid integrated optoelectronic device 1 through the optical connection waveguide member 30. The photonic integrated circuit 20 may have both of these functions.

The optical connection waveguide member 30 is arranged on the upper surface of the interconnect substrate 10. The optical connection waveguide member 30 is arranged adjacent to the photonic integrated circuit 20 and optically connected to the photonic integrated circuit 20. The end face of the optical connection waveguide member 30 is exposed alongside the end face of the interconnect substrate 10, and is optically connectable to a fiber array or the like located outside the hybrid integrated optoelectronic device 1. The optical connection waveguide member 30 is, for example, a planar lightwave circuit (PLC). The optical connection waveguide member 30 may be silicon waveguides, silicon nitride waveguides, glass waveguides, polymer waveguides, or the like.

The semiconductor device 50 is mounted on the lower surface of the interconnect substrate 10. The semiconductor device 50 is, for example, flip-chip mounted on the lower surface of the interconnect substrate 10 in a face-down state. Alternatively, the semiconductor device 50 may be mounted on the lower surface of the interconnect substrate 10 in a face-up state, and may be connected to the interconnects of the interconnect substrate 10 via bonding wires or the like. The semiconductor device 50 is electrically connected to the photonic integrated circuit 20 through the interconnects of the interconnect substrate 10. Alternatively, the semiconductor device 50 may be mounted on the upper surface of the interconnect substrate 10.

The semiconductor device 50 is, for example, a semiconductor chip. The semiconductor device 50 may alternatively be a semiconductor package in which insulating layers and redistribution interconnects are formed on the semiconductor chip. In addition to the semiconductor device 50, passive elements such as capacitors, inductors, and resistors may be mounted on the interconnect substrate 10.

The semiconductor device 50 may have the function of amplifying electrical signals input from the photonic integrated circuit 20. The electrical signals input from the photonic integrated circuit 20 are high-speed signals and thus easily attenuated. Connecting the photonic integrated circuit 20 and the semiconductor device 50 via short interconnects and amplifying the attenuating electrical signals in the semiconductor device 50 effectively improve the quality of the electrical signals output from the semiconductor device 50. When the semiconductor device 50 is mounted on the lower surface of the interconnect substrate 10, the photonic integrated circuit 20 and the semiconductor device 50 preferably overlap in plan view. This arrangement enables the photonic integrated circuit 20 and the semiconductor device 50 to be connected by short paths via through-interconnects extending through the interconnect substrate 10.

The holding member 70 holds the photonic integrated circuit 20 and the optical connection waveguide member 30 at fixed relative positions. The holding member 70 is fixed to the upper surface of the interconnect substrate 10. The holding member 70 may be made of, for example, glass or metal.

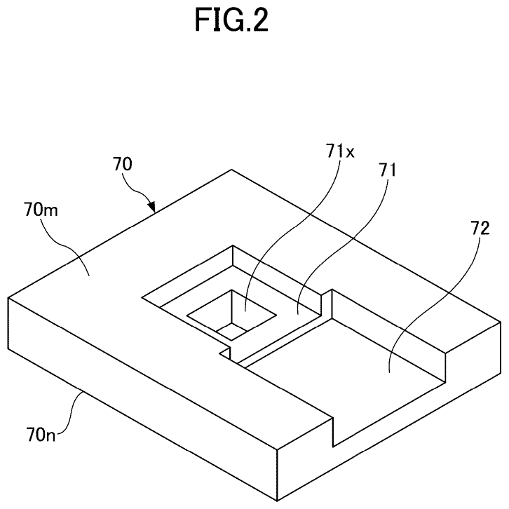

FIG. 2 is an axonometric view illustrating an example of the holding member according to the first embodiment. As illustrated in FIG. 2, the holding member 70 has recesses 71 and 72. The holding member 70 has a first surface 70m and a second surface 70n, and the recesses 71 and 72 open on the first surface 70m side. The depths of recesses may be determined as appropriate based on the heights of the components to be arranged. When the components fixed in the recesses are mounted on the interconnect substrate 10 via solder balls or the like, the depths of the recesses are determined by also factoring in the heights of the solder balls or the like.

Referring back to FIG. 1, the photonic integrated circuit 20 is fixed to the recess 71, and the optical connection waveguide member 30 is fixed to the recess 72. Any adhesive is usable for fixing the photonic integrated circuit 20 and the optical connection waveguide member 30 to the holding member 70, but the use of an ultraviolet-curable adhesive with low shrinkage is preferable. Use of an adhesive with high shrinkage would cause the positional relationship between the photonic integrated circuit 20 and the optical connection waveguide member 30 to be easily changed due to shrinkage caused by heat during the curing process.

The holding member 70 preferably has a transmittance to ultraviolet rays greater than or equal to 80%, for example. This arrangement allows the ultraviolet-curable adhesive to be irradiated by ultraviolet rays from various directions through the holding member 70, thereby effectively facilitating the curing of the ultraviolet-curable adhesive. Examples of materials having a transmittance to ultraviolet rays of 80% or more include glass.

From another viewpoint, the holding member 70 is preferably a metal material having heat radiation properties. This arrangement allows the release of heat through the holding member 70. For example, mounting a light source on the photonic integrated circuit 20 increases the amount of heat generation, which makes it preferable to have a structure capable of dissipating heat from the vicinity of the photonic integrated circuit 20. Examples of such materials include aluminum, copper, SUS, and alloys thereof.

Preferably, a through hole 71x is provided in the recess 71 of the holding member 70. When the photonic integrated circuit 20 has an alignment mark on its upper side, the photonic integrated circuit 20 may be fixed to the holding member 70 so as to place the alignment mark within the through hole 71x in plan view. This arrangement allows the alignment mark to be used to align the holding member 70 accurately at a predetermined position on the upper surface of the interconnect substrate 10 while holding the photonic integrated circuit 20 and the optical connection waveguide member 30.

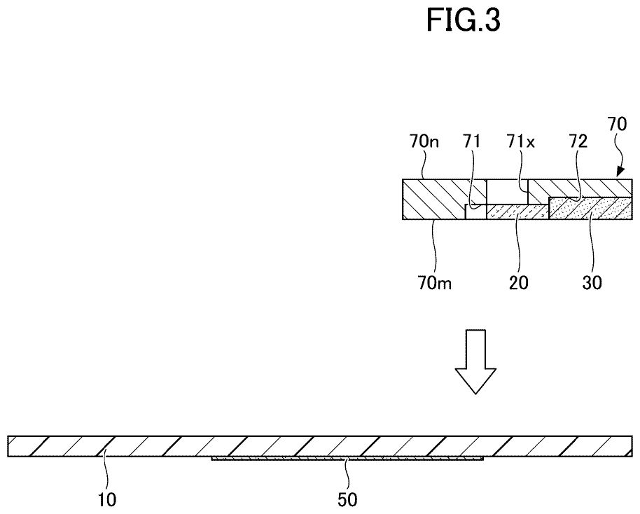

FIG. 3 is a cross-sectional view illustrating an example of a method of making a hybrid integrated optoelectronic device according to the first embodiment. To manufacture the hybrid integrated optoelectronic device 1, first, the photonic integrated circuit 20 and the optical connection waveguide member 30 are secured in the holding member 70. Specifically, an uncured ultraviolet-curable adhesive, for example, is applied to the inside of the recesses 71 and 72 of the holding member 70. The optical connection waveguide member 30 is then arranged in the recess 72. Thereafter, the photonic integrated circuit 20 is mounted in the recess 71 and connected to the optical connection waveguide member 30 by active alignment, thereby enabling the exchange of optical signals between the photonic integrated circuit 20 and the optical connection waveguide member 30. In this state, the uncured ultraviolet curable adhesive is irradiated with ultraviolet rays and cured. The holding member 70 may be produced by, for example, cutting a glass plate or a metal plate. As previously described, when the ultraviolet curable adhesive is used, the holding member 70 is preferably made of glass. Alternatively, it is also possible to mount all the components with passive alignment.

Next, the interconnect substrate 10 having the semiconductor device 50 mounted on the lower surface is prepared, and the holding member 70 holding the photonic integrated circuit 20 and the optical connection waveguide member 30 is fixed to the upper surface of the interconnect substrate 10. Specifically, for example, an uncured ultraviolet-curable adhesive is applied to the first surface 70m of the holding member 70. The structure is then placed at a predetermined position on the upper surface of the interconnect substrate 10. When the photonic integrated circuit 20 has an alignment mark on its upper side, detecting this alignment mark within the through hole 71x with the mounting machine enables the holding member 70 to be accurately arranged at the predetermined position on the upper surface of the interconnect substrate 10. At the time of arranging the holding member 70 on the upper surface of the interconnect substrate 10, electrical connections between the photonic integrated circuit 20 and the interconnect substrate 10 are established by reflow or the like. Thereafter, the uncured ultraviolet curable adhesive is irradiated with ultraviolet rays and cured. Through this process, the manufacture of the hybrid integrated optoelectronic device 1 is completed.

It may be noted that, alternatively, the photonic integrated circuit 20 and the optical connection waveguide member 30 may first be fixed to predetermined positions on the upper surface of the interconnect substrate 10. In this case also, for example, active alignment is performed to adjust the positional relationship between the photonic integrated circuit 20 and the optical connection waveguide member 30, thereby enabling the exchange of optical signals between the photonic integrated circuit 20 and the optical connection waveguide member 30.

Subsequently, an uncured ultraviolet-curable adhesive, for example, is applied to the inside of the recesses 71 and 72 of the holding member 70 and the first surface 70m of the holding member 70. The holding member 70 is then arranged on the upper surface of the interconnect substrate 10 such that the photonic integrated circuit 20 and the optical connection waveguide member 30 are positioned in the recess 71 and the recess 72, respectively. The uncured ultraviolet curable adhesive is irradiated with ultraviolet rays and cured. This completes the hybrid integrated optoelectronic device 1.

As described above, the hybrid integrated optoelectronic device 1 is configured such that the photonic integrated circuit 20 and the optical connection waveguide member 30 are held by the holding member 70 in such a manner as to enable the exchange of optical signals, and the holding member 70 is fixed to the upper surface of the interconnect substrate 10. This arrangement reduces the likelihood of concentration of stress at the connection between the photonic integrated circuit 20 and the optical connection waveguide member 30, thereby effectively reducing the risk of breakage at the connection between the photonic integrated circuit 20 and the optical connection waveguide member 30. That is, an optical connection structure with high connection reliability is effectively formed between the photonic integrated circuit 20 and the optical connection waveguide member 30. Moreover, reducing the likelihood of concentration of stress at the connection between the photonic integrated circuit 20 and the optical connection waveguide member 30 effectively reduces the occurrence of optical loss.

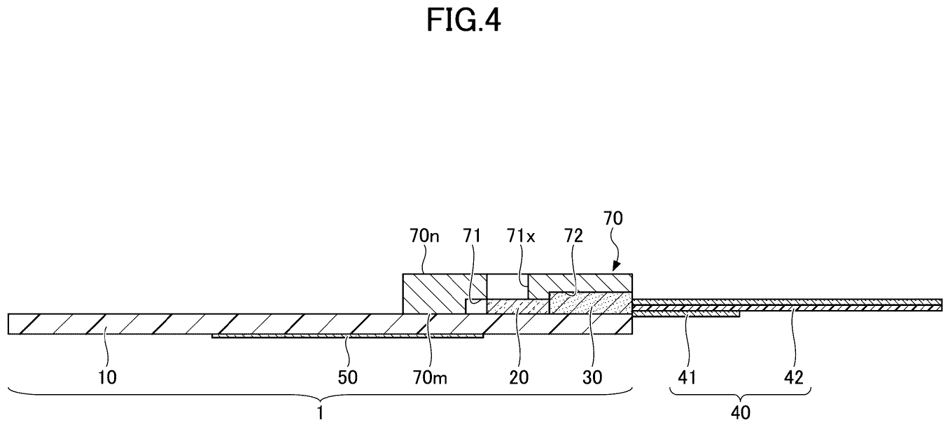

FIG. 4 is a cross-sectional view illustrating an example of the use of the hybrid integrated optoelectronic device according to the first embodiment. In the example illustrated in FIG. 4, a fiber array 40 is arranged alongside the optical connection waveguide member 30 of the hybrid integrated optoelectronic device 1. The fiber array 40 includes, for example, a support 41 and a plurality of optical fibers 42 supported by the support 41. The support 41 may be formed of, for example, glass or resin. Each optical fiber 42 of the fiber array 40 is optically connected to the optical connection waveguide member 30. The optical fibers 42 of the fiber array 40 are capable of exchanging optical signals with the photonic integrated circuit 20 via the optical connection waveguide member 30. An end of each optical fiber 42 and an opposing end of the optical connection waveguide member 30 are joined, for example, by an optical adhesive having a good transmittance to the wavelengths of optical signals exchanged between the optical fiber 42 and the optical connection waveguide member 30.

In this manner, the fiber array 40 may be arranged adjacent to the optical connection waveguide member 30 of the hybrid integrated optoelectronic device 1. In the hybrid integrated optoelectronic device 1, the photonic integrated circuit 20 and the optical connection waveguide member 30 are held by the holding member 70, and the holding member 70 is fixed to the upper surface of the interconnect substrate 10. Although heat for the reflow process or the like is applied at the time of fixing, the fiber array 40 is arranged after heating is completed, so that the fiber array 40 is not heated. This arrangement thus allows for the use of the fiber array 40 having low heat resistance.

In the case of mounting the hybrid integrated optoelectronic device 1 on another interconnect substrate or the like, heat may be applied during the mounting. In this case, heating of the fiber array 40 is effectively avoided by arranging the fiber array 40 after mounting the hybrid integrated optoelectronic device 1 on that interconnect substrate or the like. In other words, when using the fiber array 40 having low heat resistance, the fiber array 40 is preferably arranged adjacent to the optical connection waveguide member 30 of the hybrid integrated optoelectronic device 1 after all the heating steps are completed.

### First Variation of First Embodiment

A first variation of the first embodiment is directed to an example of a hybrid integrated optoelectronic device having a holding member that is configured to hold a fiber array in addition to the photonic integrated circuit and the optical connection waveguide member. In connection with the first variation of the first embodiment, descriptions may be omitted with respect to the same components as those of the already described embodiment.

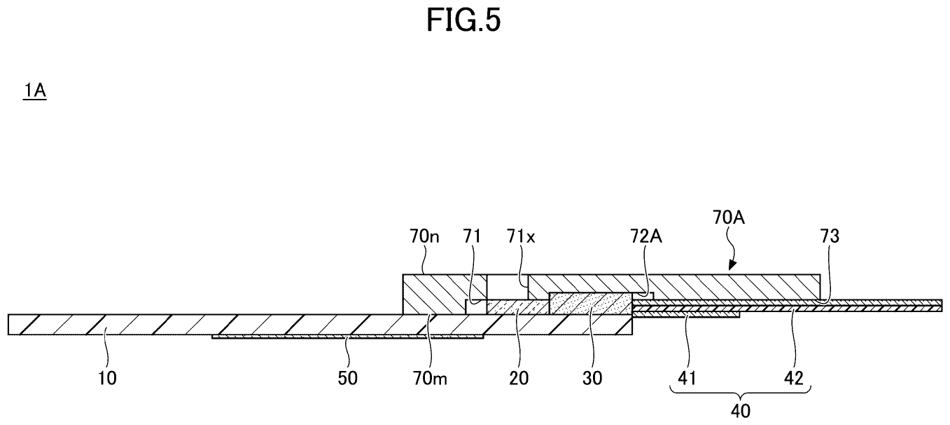

FIG. 5 is a cross-sectional view illustrating an example of a hybrid integrated optoelectronic device according to the first variation of the first embodiment. Referring to FIG. 5, a hybrid integrated optoelectronic device 1A differs from the hybrid integrated optoelectronic device 1 in that it includes a fiber array 40 and a holding member 70A instead of the holding member 70.

The structure of the fiber array 40 is the same as that illustrated in FIG. 4. The fiber array 40 is located opposite the photonic integrated circuit 20 across the optical connection waveguide member 30. The optical connection waveguide member 30 is optically connected to the photonic integrated circuit 20 and the fiber array 40.

That is, each optical fiber 42 of the fiber array 40 is optically connected to the optical connection waveguide member 30. The optical fibers 42 of the fiber array 40 are capable of exchanging optical signals with the photonic integrated circuit 20 via the optical connection waveguide member 30. An end of each optical fiber 42 and an opposing end of the optical connection waveguide member 30 are joined, for example, by an optical adhesive having a good transmittance to the wavelengths of optical signals exchanged between the optical fiber 42 and the optical connection waveguide member 30.

The holding member 70A holds the photonic integrated circuit 20, the optical connection waveguide member 30, and the fiber array 40 in fixed relative positions. The holding member 70A is fixed to the upper surface of the interconnect substrate 10.

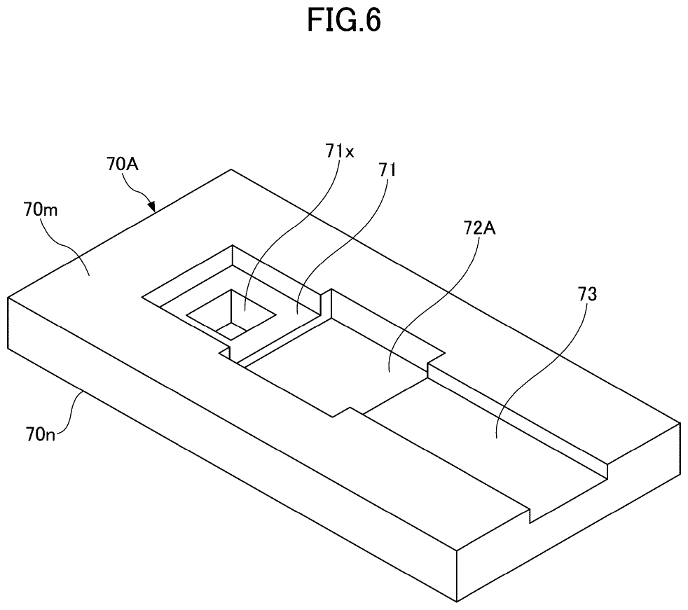

FIG. 6 is an axonometric view illustrating an example of the holding member according to the first variation of the first embodiment. As illustrated in FIG. 6, the holding member 70A has a recess 71, a recess 72A, and a recess 73. The holding member 70A has a first surface 70m and a second surface 70n, and the recess 71, the recess 72A, and the recess 73 open on the first surface 70m side. The recess 72A is longer than the recess 72 in the longitudinal direction of the holding member 70A. This allows easy arrangement of the optical connection waveguide member 30. The depths of the recesses may be determined as appropriate based on the heights of the components to be arranged. When the components fixed in the recesses are mounted on the interconnect substrate 10 via solder balls or the like, the depths of the recesses are determined by also factoring in the heights of the solder balls or the like.

Referring back to FIG. 5, the photonic integrated circuit 20 is fixed to the recess 71, and the optical connection waveguide member 30 is fixed to the recess 72A with the fiber array 40 fixed to the recess 73. Although any adhesive may be used to fix the photonic integrated circuit 20, the optical connection waveguide member 30, and the fiber array 40 to the holding member 70A, the use of an ultraviolet-curable adhesive with low shrinkage is preferable. Use of an adhesive with high shrinkage would cause the positional relationship among the photonic integrated circuit 20, the optical connection waveguide member 30, and the fiber array 40 to be easily changed due to shrinkage caused by heat during the curing process.

Like the holding member 70, the holding member 70A may be formed of a material having a high ultraviolet transmittance such as glass. The holding member 70A may be formed of a metal material having heat dissipation properties such as aluminum, copper, SUS, or an alloy thereof. Like the holding member 70, the holding member 70A preferably has a through hole 71x in the recess 71.

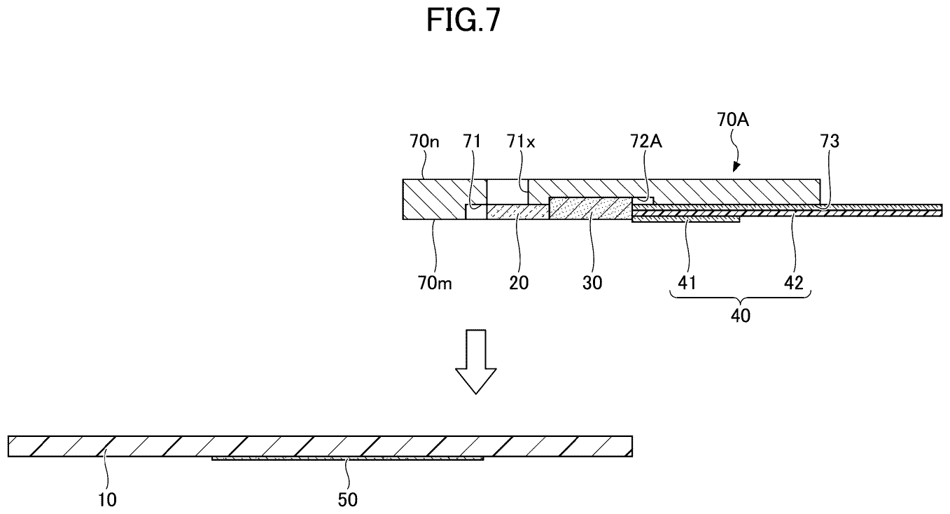

FIG. 7 is a cross-sectional view illustrating an example of a manufacturing method of the hybrid integrated optoelectronic device according to the first variation of the first embodiment. To manufacture the hybrid integrated optoelectronic device 1A, first, the photonic integrated circuit 20, the optical connection waveguide member 30, and the fiber array 40 are secured in the holding member 70A. Specifically, an uncured ultraviolet-curable adhesive, for example, is applied to the inside of the recess 71, the recess 72A, and the recess 73 of the holding member 70A. The optical connection waveguide member 30 is then arranged in the recess 72A, and the fiber array 40 is arranged in the recess 73. Active alignment, for example, is performed to adjust the positional relationship between the optical connection waveguide member 30 and the fiber array 40. Subsequently, the photonic integrated circuit 20 is mounted in the recess 71 and connected to the optical connection waveguide member 30 by active alignment, thereby enabling the exchange of optical signals among the photonic integrated circuit 20, the optical connection waveguide member 30, and the fiber array 40. In this state, the uncured ultraviolet-curable adhesive is irradiated with ultraviolet rays and cured. The holding member 70A may be manufactured, for example, by cutting a glass plate or a metal plate. As described above, when the ultraviolet-curable adhesive is used, the holding member 70A is preferably made of glass. Alternatively, it is also possible to mount all the components with passive alignment.

Next, as in the first embodiment, an interconnect substrate 10 having a semiconductor device 50 mounted on the lower surface thereof is prepared, and the holding member 70A holding the photonic integrated circuit 20, the optical connection waveguide member 30, and the fiber array 40 is fixed to the upper surface of the interconnect substrate 10. Through this process, the manufacture of the hybrid integrated optoelectronic device 1A is completed.

It may be noted that, alternatively, the photonic integrated circuit 20, the optical connection waveguide member 30, and the fiber array 40 may first be fixed to predetermined positions on the upper surface of the interconnect substrate 10. In this case also, active alignment, for example, is performed to adjust the positional relationship among the photonic integrated circuit 20, the optical connection waveguide member 30, and the fiber array 40, thereby enabling the exchange of optical signals among the photonic integrated circuit 20, the optical connection waveguide member 30, and the fiber array 40.

Subsequently, an uncured ultraviolet-curable adhesive, for example, is applied to the inside of the recesses 71, 72A, and 73 of the holding member 70A and the first surface 70m of the holding member 70A. The holding member 70A is arranged on the upper surface of the interconnect substrate 10 such that the photonic integrated circuit 20, the optical connection waveguide member 30, and the fiber array 40 are positioned in the recesses 71, 72A, and 73, respectively. The uncured ultraviolet curable adhesive is irradiated with ultraviolet rays and cured. Through this process, the manufacture of the hybrid integrated optoelectronic device 1A is completed.

As described above, the hybrid integrated optoelectronic device 1A is configured such that the photonic integrated circuit 20, the optical connection waveguide member 30, and the fiber array 40 are held by the holding member 70A in such a manner as to enable the exchange of optical signals, and the holding member 70A is fixed to the upper surface of the interconnect substrate 10. This arrangement reduces the likelihood of concentration of stress at the connection between the photonic integrated circuit 20 and the optical connection waveguide member 30, thereby effectively reducing the risk of breakage at the connection between the photonic integrated circuit 20 and the optical connection waveguide member 30. This arrangement also reduces the likelihood of concentration of stress at the connection between the optical connection waveguide member 30 and the fiber array 40, thereby effectively reducing the risk of breakage at the connection between the optical connection waveguide member 30 and the fiber array 40. That is, optical connection structures with high connection reliability are effectively formed at the connection between the photonic integrated circuit 20 and the optical connection waveguide member 30 and at the connection between the optical connection waveguide member 30 and the fiber array 40. Moreover, the occurrence of optical loss is reduced by the lowered likelihood of concentration of stress at the connection between the photonic integrated circuit 20 and the optical connection waveguide member 30 and the connection between the optical connection waveguide member 30 and the fiber array 40.

In the hybrid integrated optoelectronic device 1A, the photonic integrated circuit 20, the optical connection waveguide member 30, and the fiber array 40 are held by the holding member 70A, and the holding member 70A is fixed to the upper surface of the interconnect substrate 10. Since heat for a reflow process or the like is applied at the time of fixing, the use of a fiber array with high heat resistance is preferable. In other words, when a fiber array with low heat resistance is used, the holding member 70 employed in the first embodiment is preferably used, and the fiber array is arranged after all the heating steps are completed.

### Second Variation of First Embodiment

The second variation of the first embodiment is directed to an example of a hybrid integrated optoelectronic device which does not have the optical connection waveguide member 30. In connection with the second variation of the first embodiment, descriptions may be omitted with respect to the same components as those of the already described embodiments.

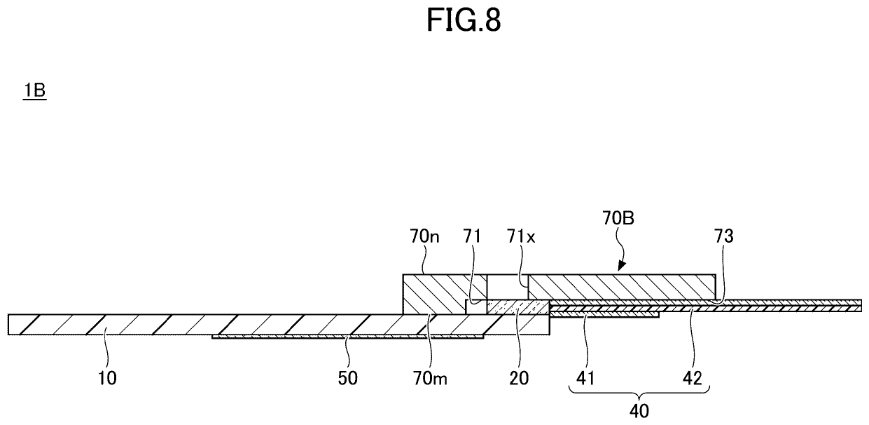

FIG. 8 is a cross-sectional view illustrating an example of a hybrid integrated optoelectronic device according to the second variation of the first embodiment. Referring to FIG. 8, a hybrid integrated optoelectronic device 1B differs from the hybrid integrated optoelectronic device 1A in that it does not have the optical connection waveguide member 30 and includes a holding member 70B instead of the holding member 70.

In the hybrid integrated optoelectronic device 1B, the holding member 70B holds the photonic integrated circuit 20 and the fiber array 40 in fixed relative positions. The holding member 70B is fixed to the upper surface of the interconnect substrate 10. Each optical fiber 42 of the fiber array 40 is optically connected to the photonic integrated circuit 20. Each optical fiber 42 of the fiber array 40 is capable of exchanging optical signals with the photonic integrated circuit 20. An end of each optical fiber 42 and an opposing end of the photonic integrated circuit 20 are joined, for example, by an optical adhesive having a good transmittance to the wavelengths of optical signals exchanged between the optical fiber 42 and the photonic integrated circuit 20.

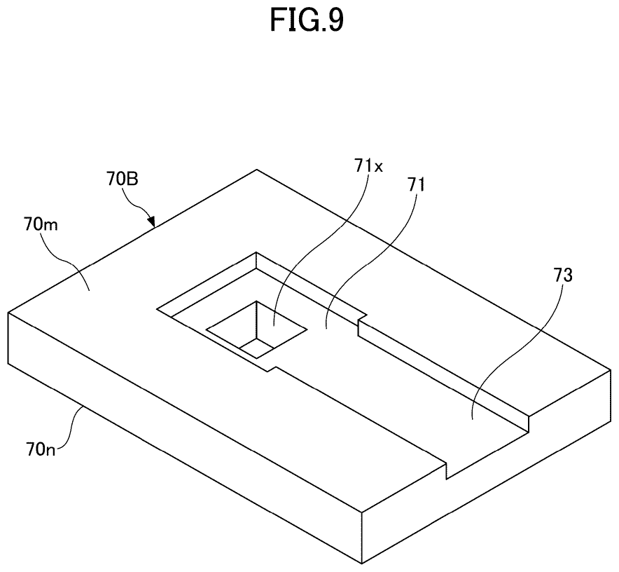

FIG. 9 is an axonometric view illustrating an example of the holding member according to the second variation of the first embodiment. As illustrated in FIG. 9, the holding member 70B has a recess 71 and a recess 73. The holding member 70B has a first surface 70m and a second surface 70n, and the recess 71 and the recess 73 open on the first surface 70m side. The recess 71 and the recess 73 may or may not have the same depth from the first surface 70m.

Referring back to FIG. 8, the photonic integrated circuit 20 is fixed to the recess 71, and the fiber array 40 is fixed to the recess 73. Although any adhesive may be used to fix the photonic integrated circuit 20 and the fiber array 40 to the holding member 70B, the use of an ultraviolet-curable adhesive as in the first embodiment is preferable. In this case, the holding member 70B preferably has a transmittance to ultraviolet rays greater than or equal to 80% as in the first embodiment. Also, as in the first embodiment, a through hole 71x is preferably provided in the recess 71 of the holding member 70B.

In this manner, the photonic integrated circuit 20 and the fiber array 40 may be directly optically connected. In this case also, the photonic integrated circuit 20 and the fiber array 40 are held by the holding member 70B in such a manner as to enable the exchange of optical signals, and the holding member 70B is fixed to the upper surface of the interconnect substrate 10, which reduces the likelihood of concentration of stress at the connection between the photonic integrated circuit 20 and the fiber array 40. This arrangement effectively reduces the likelihood of breakage at the connection between the photonic integrated circuit 20 and the fiber array 40. That is, an optical connection structure with high connection reliability is effectively formed at the connection between the photonic integrated circuit 20 and the fiber array 40.

Although the preferred embodiments and their variations have been described in detail above, the invention is not limited to the above-described embodiments and their variations, and various modifications and substitutions may be made to the above-described embodiments and their variations without departing from the scope of the claims.

For example, two or more holding members separate from each other may be arranged on one interconnect substrate. Moreover, an ASIC (application specific integrated circuit), a memory, or the like may be arranged on the upper and/or lower surfaces of the interconnect substrate.

According to at least one embodiment, a hybrid integrated optoelectronic device having an optical connection structure with high connection reliability is effectively provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A hybrid integrated optoelectronic device comprising:
an interconnect substrate;
a photonic integrated circuit disposed on an upper surface of the interconnect substrate;
an optical connection waveguide member disposed on the upper surface of the interconnect substrate; and
a holding member configured to hold the photonic integrated circuit and the optical connection waveguide member,
wherein the holding member is fixed to the upper surface of the interconnect substrate.

2. The hybrid integrated optoelectronic device according to claim 1, wherein the holding member has a first recess and a second recess, and
wherein the photonic integrated circuit is fixed to the first recess, and the optical connection waveguide member is fixed to the second recess.

3. The hybrid integrated optoelectronic device according to claim 2, further comprising a fiber array configured to exchange optical signals with the photonic integrated circuit via the optical connection waveguide member, and
wherein the holding member further has a third recess, and the fiber array is fixed to the third recess.

4. A hybrid integrated optoelectronic device comprising:
an interconnect substrate;
a photonic integrated circuit disposed on an upper surface of the interconnect substrate;
a fiber array configured to exchange optical signals with the photonic integrated circuit; and
a holding member configured to hold the photonic integrated circuit and the fiber array,
wherein the holding member is fixed to the upper surface of the interconnect substrate.

5. The hybrid integrated optoelectronic device according to claim 4, wherein the holding member has a first recess and a second recess, and
wherein the photonic integrated circuit is fixed to the first recess, and the fiber array is fixed to the second recess.

6. The hybrid integrated optoelectronic device according to claim 3, wherein the photonic integrated circuit and the fiber array are fixed to the holding member by an ultraviolet curable adhesive, and the holding member has a transmittance to ultraviolet light of 80% or more.

7. The hybrid integrated optoelectronic device according to claim 6, wherein the holding member is made of glass.

8. The hybrid integrated optoelectronic device according to claim 2, wherein the photonic integrated circuit includes an alignment mark, and a through hole is provided in the first recess, and
wherein the alignment mark is located within the through hole in plan view.
